(19) United States
(12) Patent Application Publication
(10) Pub. No.: US 2021/0358181 A1
(43) Pub. Date: Nov. 18, 2021

(54) DISPLAY DEVICE AND DISPLAY CONTROL METHOD

(71) Applicant: SONY GROUP CORPORATION, TOKYO (JP)

(72) Inventors: TAKESHI SUZUKI, TOKYO (JP); REI ABO, TOKYO (JP)

(21) Appl. No.: 17/287,339

(22) PCT Filed: Oct. 16, 2019
(86) PCT No.: PCT/JP2019/040574

§ 371 Date: Apr. 21, 2021

(30) Foreign Application Priority Data
Oct. 29, 2018 (JP) 2018-202810

(51) Int. Cl. G06T 11/00; G06F 3/16; G06T 5/00; H04N 5/76; G09G 3/34; G09G 3/36; G09G 3/20; H04N 7/18; G06F 3/14; G06Q 30/06; A45D 44/00; A47G 1/02

(52) U.S. Cl. CPC G06T 11/00; A47G 2001/002; G06T 5/002; H04N 5/76; G09G 3/3406; G09G 3/36; G09G 3/2003; H04N 7/18; G06F 3/14; G06Q 30/0601; A45D 44/005; A47G 1/02; G09G 2320/0686; G09G 2320/0666; G06T 2207/10016; G06F 3/167

(57) ABSTRACT

The present technology relates to a display device and a display control method that enable improvement of user experience. Provided is a display device including: a control unit that, when displaying a video corresponding to an image frame obtained by capturing a user on a display unit, controls luminance of a lighting region including a first region including the user in the image frame and at least a part of a second region of the second region excluding the first region to cause the lighting region to function as a light that emits light to the user. The present technology can be applied, for example, to a television receiver.

### TECHNICAL FIELD

The present technology relates to a display device and a display control method, and more particularly to a display device and a display control method that enable improvement of user experience.

### BACKGROUND ART

In recent years, display devices such as television receivers can provide various functions as their performance increases (see, for example, Patent Document 1).

### CITATION LIST

### Patent Document

Patent Document 1: U.S. Pat. No. 9,198,496

### SUMMARY OF THE INVENTION

### Problems to be Solved by the Invention

By the way, in display devices such as television receivers, improvement of user experience has been demanded when providing various functions.

The present technology has been made in view of such circumstances and enables improvement of the user experience.

### Solutions to Problems

The display device according to an aspect of the present technology is a display device including: a control unit that, when displaying a video corresponding to an image frame obtained by capturing a user on a display unit, controls luminance of a lighting region including a first region including the user in the image frame and at least a part of a second region of the second region excluding the first region to cause the lighting region to function as a light that emits light to the user.

The display control method according to an aspect of the present technology is a display control method in which a display device, when displaying a video corresponding to an image frame obtained by capturing a user on a display unit, controls luminance of a lighting region including a first region including the user in the image frame and at least a part of a second region of the second region excluding the first region to cause the lighting region to function as a light that emits light to the user.

With the display device and the display control method according to an aspect of the present technology, when a video corresponding to an image frame obtained by capturing a user is displayed on a display unit, luminance of a lighting region including a first region including the user in the image frame and at least a part of a second region of the second region excluding the first region is controlled to cause the lighting region function as a light that emits light to the user.

The display device of one aspect of the present technology may be an independent device, or may be an internal block constituting a single device.

### BRIEF DESCRIPTION OF DRAWINGS

FIG. 1 is a diagram showing an example of a system configuration to which the present technology has been applied.

FIG. 2 is a block diagram showing an example of a configuration of a display device to which the present technology has been applied.

FIG. 3 is a block diagram showing a configuration example of a display unit of FIG. 2.

FIG. 4 is a diagram showing a first example of a display screen displayed on a display device.

FIG. 5 is a diagram showing a first example of eye-catching lighting.

FIG. 6 is a diagram showing a second example of eye-catching lighting.

FIG. 7 is a diagram showing a second example of a display screen displayed on a display device.

FIG. 8 is a diagram showing a second example of a display screen displayed on a display device.

FIG. 9 is a diagram showing an example of installation of a plurality of camera units.

FIG. 10 is a diagram showing an example of background processing of a display screen.

FIG. 11 is a diagram showing a third example of a display screen displayed on a display device.

FIG. 12 is a diagram showing a fourth example of a display screen displayed on a display device.

FIG. 13 is a diagram showing a fifth example of a display screen displayed on a display device.

FIG. 14 is a diagram showing a sixth example of a display screen displayed on a display device.

FIG. 15 is a diagram showing an example of switching timing to a smart mirror function.

FIG. 16 is a flowchart explaining a processing flow of a display device.

FIG. 17 is a flowchart explaining a processing flow of a display device.

FIG. 18 is a flowchart explaining a processing flow of a display device.

FIG. 19 is a flowchart explaining a processing flow of a display device.

FIG. 20 is a diagram explaining a first example of a function of a display device.

FIG. 21 is a diagram explaining a second example of a function of a display device.

FIG. 22 is a block diagram showing another configuration example of a display unit of FIG. 2.

FIG. 23 is a diagram showing a configuration example of a computer.

### MODE FOR CARRYING OUT THE INVENTION

Embodiments of the present technology are described below with reference to the drawings. Note that the description is given in the order below.

1. Embodiments of the present technology

2. Variation

3. Configuration of computer

<1. Embodiments of the Present Technology>

(Configuration of System)

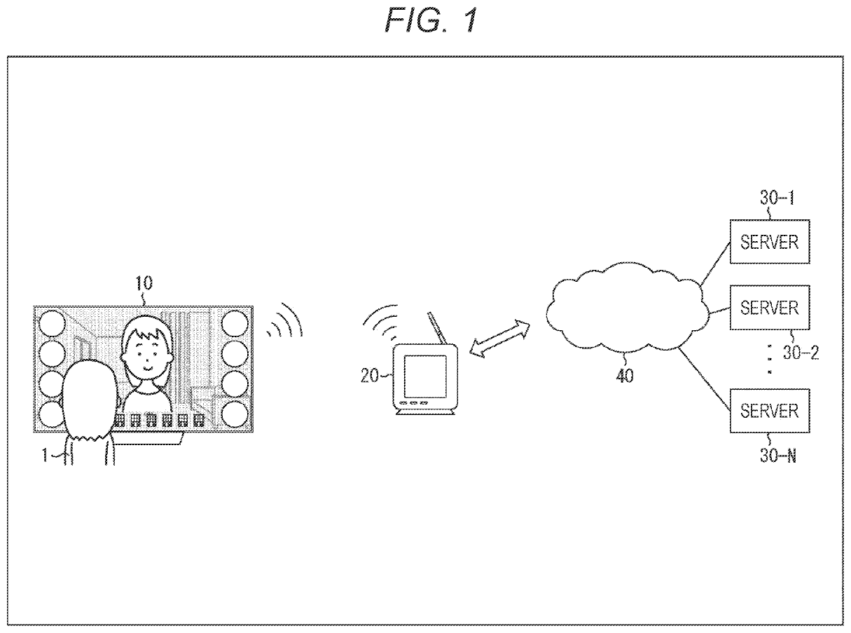

FIG. 1 is a diagram showing an example of a system configuration to which the present technology has been applied.

A display device 10 includes, for example, a television receiver or the like. By receiving and processing a broadcast signal, the display device 10 displays the video of the broadcast content and outputs its sound. Therefore, a user 1 can watch and listen to broadcast contents such as TV programs.

Furthermore, the display device 10 has a capture function, and by capturing (imaging) the user 1 located in front by a camera unit and displaying its video, the display device 10 functions as a mirror that reflects the user 1. Moreover, when the user 1 uses the display device 10 as a mirror, the display device 10 controls the backlight provided for a liquid crystal display unit to function as lighting for makeup and eye catching.

The display device 10 also has a communication function such as a wireless local area network (LAN). For example, by communicating with a router 20 installed in a room, the display device 10 can access servers 30-1 to 30-N (N is an integer greater than or equal to 1) via a network 40 such as the Internet. The servers 30-1 to 30-N are servers that provide various services.

For example, the server 30-1 is a server that provides a website such as an electronic commerce (EC) site or an electronic shopping street (cyber mall), and the display device 10 can present information (web page) for purchasing products such as cosmetics. Furthermore, for example, the server 30-2 is a server that provides a social networking service (SNS). Moreover, for example, the server 30-3 is a server that distributes communication content such as moving images, and the server 30-4 is a server that distributes an application that can be executed by the display device 10. Note that although not described further, various services are provided also by the servers 30-4 to 30-N.

As described above, the display device 10 has a function as a so-called smart mirror in addition to the function as a general television receiver.

(Configuration of the Display Device)

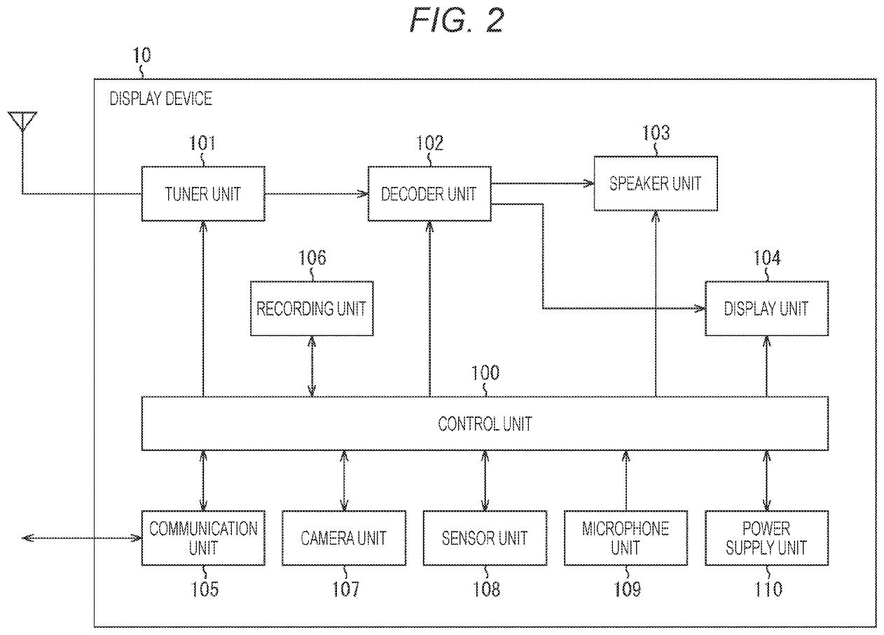

FIG. 2 is a block diagram showing an example of a configuration of a display device to which the present technology has been applied.

In FIG. 2, the display device 10 includes a control unit 100, a tuner unit 101, a decoder unit 102, a speaker unit 103, a display unit 104, a communication unit 105, a recording unit 106, a camera unit 107, a sensor unit 108, a microphone unit 109, and a power supply unit 110.

The control unit 100 includes, for example, a central processing unit (CPU), a microcomputer, and the like. The control unit 100 controls the operation of each unit of the display device 10.

A broadcast signal transmitted from a transmitting station and received via a receiving antenna is input to the tuner unit 101. The tuner unit 101 performs necessary processing (for example, demodulation processing or the like) on the received signal according to the control from the control unit 100, and supplies the resulting stream to the decoder unit 102.

A video stream and a sound stream are supplied to the decoder unit 102 as streams supplied from the tuner unit 101.

The decoder unit 102 decodes the sound stream according to the control from the control unit 100, and supplies the resulting sound signal to the speaker unit 103. Furthermore, the decoder unit 102 decodes the video stream according to the control from the control unit 100, and supplies the resulting video signal to the display unit 104.

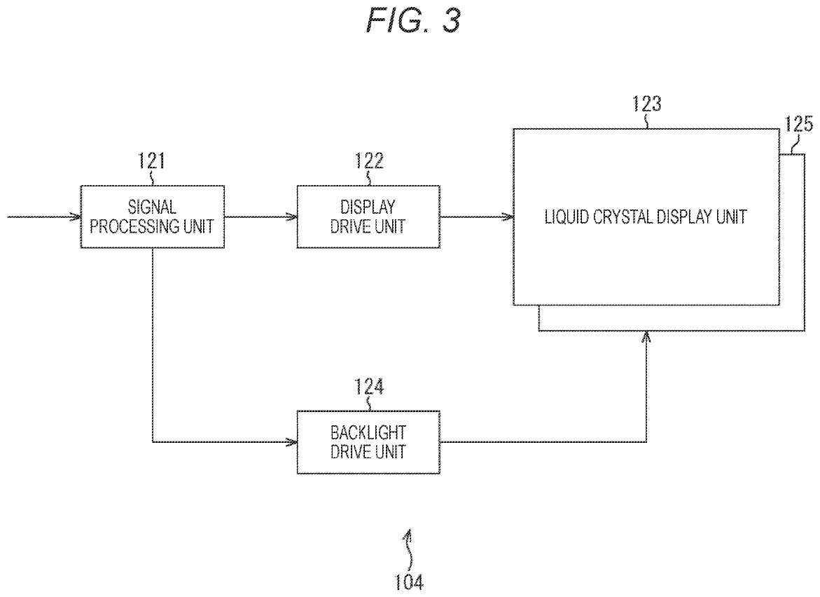

The speaker unit 103 performs necessary processing on the sound signal supplied from the decoder unit 102 according to the control from the control unit 100, and outputs a sound corresponding to the sound signal. The display unit 104 performs necessary processing on the video signal supplied from the decoder unit 102 according to the control from the control unit 100, and displays a video corresponding to the video signal. Note that a detailed configuration of the display unit 104 will be described later with reference to FIG. 3.

The communication unit 105 includes a communication module that supports wireless communication such as wireless LAN, cellular communication (for example, LTE-Advanced, 5G, or the like), and the like. The communication unit 105 exchanges various data with the server 30 via the network 40 according to the control from the control unit 100.

The recording unit 106 includes a storage device such as a semiconductor memory, a hard disk drive (HDD), or a buffer device for temporarily storing data. The recording unit 106 records various data according to the control from the control unit 100.

The camera unit 107 includes, for example, an image sensor such as a complementary metal oxide semiconductor (CMOS) image sensor or a charge coupled device (CCD) image sensor, and a signal processing unit such as a camera image signal processor (ISP).

The camera unit 107 performs various signal processing by the signal processing unit on a capture signal obtained by capturing a subject by the image sensor according to the control from the control unit 100. The camera unit 107 supplies the video signal of the image frame obtained as a result of the signal processing to the control unit 100.

Note that the camera unit 107 may be built into the display device 10 or externally attached via a predetermined interface. Furthermore, the number of camera units 107 is not limited to one, but a plurality of camera units 107 may be provided at predetermined positions on the display device 10.

The sensor unit 108 includes various sensors. The sensor unit 108 performs sensing for obtaining various information about the periphery of the display device 10 according to the control from the control unit 100. The sensor unit 108 supplies the sensor data according to the sensing result to the control unit 100.

The sensor unit 108 can include various sensors such as a color sensor that detects the ambient color temperature, a distance measuring sensor that measures the distance to a target object, and an ambient light sensor that detects the ambient brightness.

The microphone unit 109 converts an external sound (voice) into an electric signal, and supplies the resulting sound signal to the control unit 100.

The power supply unit 110 supplies a power supply power obtained from an external power source or a storage battery to each unit of the display device 10 including the control unit 100 according to the control from the control unit 100.

(Configuration of the Display Unit)

FIG. 3 is a block diagram showing a configuration example of the display unit 104 of FIG. 2.

In FIG. 3, the display unit 104 includes a signal processing unit 121, a display drive unit 122, a liquid crystal display unit 123, a backlight drive unit 124, and a backlight 125.

The signal processing unit 121 performs predetermined video signal processing on the basis of the video signal input thereto. In this video signal processing, a video signal for controlling the drive of the liquid crystal display unit 123 is generated and supplied to the display drive unit 122. Furthermore, in this video signal processing, a drive control signal (BL drive control signal) for controlling the drive of the backlight 125 is generated and supplied to the backlight drive unit 124.

The display drive unit 122 drives the liquid crystal display unit 123 on the basis of the video signal supplied from the signal processing unit 121. The liquid crystal display unit 123 is a display panel in which pixels including a liquid crystal element and a thin film transistor (TFT) element are arranged in a two-dimensional manner, and modulates the light emitted from the backlight 125 according to the drive from the display drive unit 122 to perform display.

The liquid crystal display unit 123 includes, for example, a liquid crystal material enclosed between two transparent substrates including glass or the like. A transparent electrode including, for example, indium tin oxide (ITO) is formed on a portion of these transparent substrates facing the liquid crystal material, and constitutes a pixel together with the liquid crystal material. Note that in the liquid crystal display unit 123, each pixel includes, for example, three sub-pixels, red (R), green (G), and blue (B).

The backlight drive unit 124 drives the backlight 125 on the basis of a drive control signal (BL drive control signal) supplied from the signal processing unit 121. The backlight 125 emits light emitted by a plurality of light emitting elements to the liquid crystal display unit 123 according to the drive from the backlight drive unit 124. Note that as the light emitting element, for example, a light emitting diode (LED) can be used.

Here, the backlight 125 may be divided into a plurality of partial light emitting regions, and one or a plurality of light emitting elements such as LEDs is arranged in each partial light emitting region. At this time, the backlight drive unit 124 may perform lighting control, so-called partial drive, in which the BL drive control signal is changed for each partial light emitting region. Furthermore, here, the dynamic range of the luminance can be improved by utilizing the partial drive of the backlight 125. This technique for improving the dynamic range of luminance is also called “luminance enhancement” and is realized by, for example, the following principle.

That is, in a case where the display unit 104 uniformly displays a 100% white video as the luminance level of the video signal on the entire screen, all of the plurality of partial light emitting regions of the backlight 125 are turned on. It is assumed that the output luminance of the display unit 104 in this state is 100%, the power consumption of the backlight 125 is 200 W per half of the entire light emitting region, and the power consumption of the entire backlight 125 is 400 W. Furthermore, it is assumed that the backlight 125 has a power limit of 400 W as a whole.

On the other hand, a case is assumed in which, in the display unit 104, black is displayed on the half of the screen with the minimum luminance level of the video signal and white is displayed on the other half of the screen with the luminance level of the video signal being 100%. In this case, the black display portion can turn off the backlight 125 and reduce the power consumption of the backlight 125 to 0 W. On the other hand, the backlight 125 in the white display portion may consume 200 W, but in that case, by turning off the black display portion, a power margin of 200 W is created. Then, it is possible to increase the power of the backlight 125 in the white display portion to 200 W+200 W=400 W. Therefore, a maximum output luminance value L_{MAX} in the display unit 104 can be increased to 200% as compared with the above example. By such principle, “luminance enhancement” is realized.

Note that the configuration of the display device 10 shown in FIG. 2 is an example, and other components can be included. For example, in a case where the display device 10 as a television receiver is operated by using a remote controller, a light receiving unit or the like that receives an infrared signal is provided.

Furthermore, for example, the display device 10 may reproduce not only broadcast content such as TV programs, but also content such as communication content such as moving images distributed from the server 30-3, or recorded content input via an interface that supports a predetermined scheme such as high-definition multimedia interface (HDMI) (registered trademark) or universal serial bus (USB). Moreover, the display device 10 can download and execute an application (for example, a smart mirror application) distributed from the server 30-4. The application may be, for example, a native application executed by the control unit 100, or a web application that executes a browser and displays a screen.

(Smart Mirror Function)

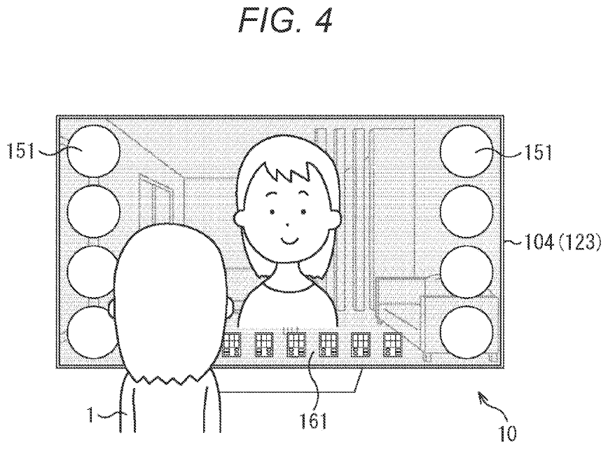

Next, the smart mirror function of the display device 10 will be described with reference to FIGS. 4 to 15.

### First Example

FIG. 4 shows a first example of a display screen displayed on the display device 10.

In FIG. 4, the display device 10 captures the user 1 located in front thereof with the camera unit 107, and displays the video on (the liquid crystal display unit 123 of) the display unit 104.

In the central region of this display screen, the video of the user 1 located in front thereof is displayed. Furthermore, in the left and right regions (lighting regions) of the display screen, a plurality of, four, lights 151 as eye-catching lighting is displayed in the vertical direction, and in the lower region of the display screen, product information 161 related to a product such as cosmetics is displayed.

Here, by displaying the plurality of lights 151 in the left and right regions as the eye-catching lighting, for example, in a dressing room where an actress makes up or in a cosmetics section in a department store, it is possible to illuminate (the face of) the user 1 evenly from various angles (to eliminate the shadow of the face) so that makeup can be performed correctly. When displaying a plurality of lights 151, the control unit 100 controls the luminance of the backlight 125 of the display unit 104 according to the brightness of the lighting region. Here, for example, the above-mentioned technology “luminance enhancement” is applied to increase the power of the backlight 125 in the white display part (lighting region), and it is possible to realize the eye-catching lighting.

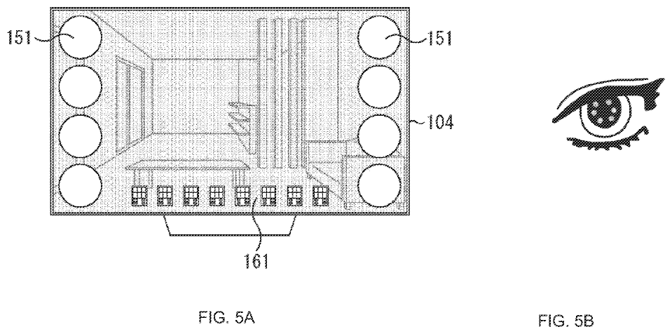

In this way, the display device 10 displays the plurality of lights 151 as the eye-catching lighting so that the optimum lighting for makeup is reproduced at the home of the user 1 (A of FIG. 5). At this time, the video of the user 1 displayed on the display device 10 is in a state of being illuminated by the plurality of left and right lights 151. For example, the plurality of left and right lights 151 is reflected in the pupil of the user 1 (B of FIG. 5).

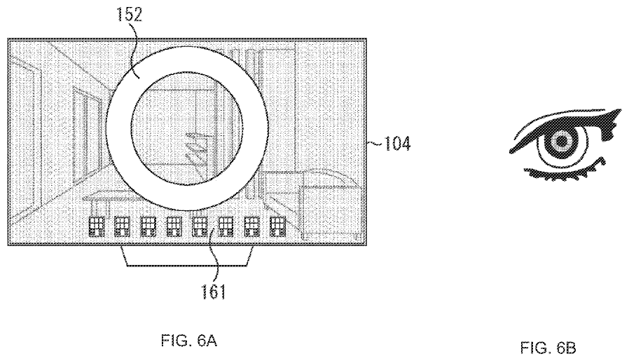

Note that the eye-catching lighting is not limited to the plurality of lights 151 vertically displayed in the left and right regions, but, for example, lights having a predetermined shape may be provided. A of FIG. 6 shows an example of a case where a donut-shaped light 152 is displayed as the eye-catching lighting. In this case, the donut-shaped light 152 is reflected in the pupil as the video of the user 1 displayed on the display device 10 (B of FIG. 6). Moreover, the number of lights is not limited to four in the vertical direction, but any number can be displayed.

Furthermore, as the eye-catching lighting, a plurality of lights may be displayed in the lateral direction in the upper and lower regions. That is, the display device 10 can display a plurality of lights as the lighting region in at least some of the upper, lower, left, and right regions of the display screen on the display unit 104. Here, the lighting region is a region including a first region including (the image of) the user 1 in the image frame and at least a part of a second region within the second region (region including the background) excluding the first region.

### Second Example

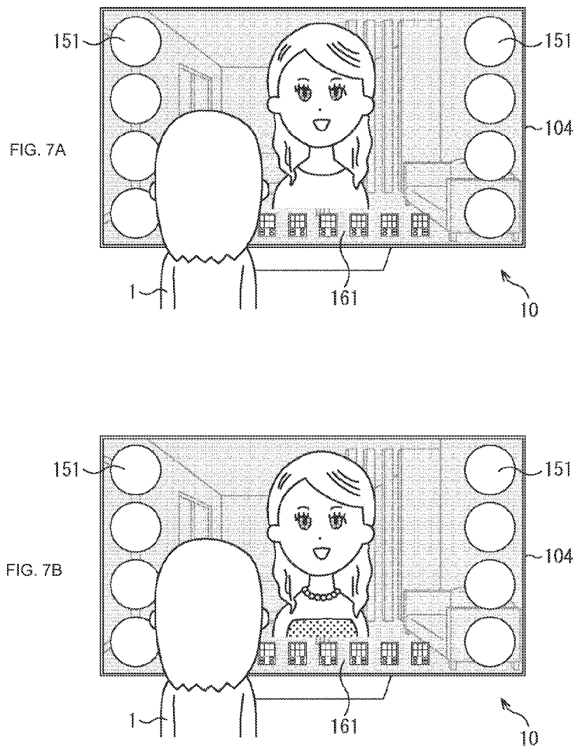

FIG. 7 shows a second example of a display screen displayed on the display device 10.

In FIG. 7, the display device 10 captures the user 1 located in front thereof with the camera unit 107, and when the video is displayed on the display unit 104, the display device 10 uses augmented reality (AR) technology (AR technology) to display various information (virtual information) that does not exist in the real world (real space) in a superimposing manner. Note that as the AR technology, a known technology such as a markerless type or a marker type AR can be used.

Here, for example, the video of the face of the user 1 on the display screen is made up by AR technology (A of FIG. 7). Furthermore, the superimposed display by the AR technology is not limited to makeup, and for example, costumes (clothes) and accessories may be superimposed and displayed on the video of the user 1 on the display screen (B of FIG. 7). For example, the user 1 can register information regarding his/her wardrobe (costumes) and accessories in advance, so that the display device 10 can present a recommended combination of costumes and accessories.

Note that the user 1 may register the information regarding costumes or the like by operating the display device 10 or by activating a dedicated application on a mobile terminal such as a smartphone or a tablet terminal. Furthermore, the recommended combination of costumes or the like may be determined by (the control unit 100 of) the display device 10 using a predetermined algorithm, or a dedicated server 30 such as a recommendation server using machine learning, for example, may be contacted via the network 40. Further, the user 1 may select the combination of costumes and accessories by himself/herself instead of the device side such as the display device 10 or the like presenting a recommended combination.

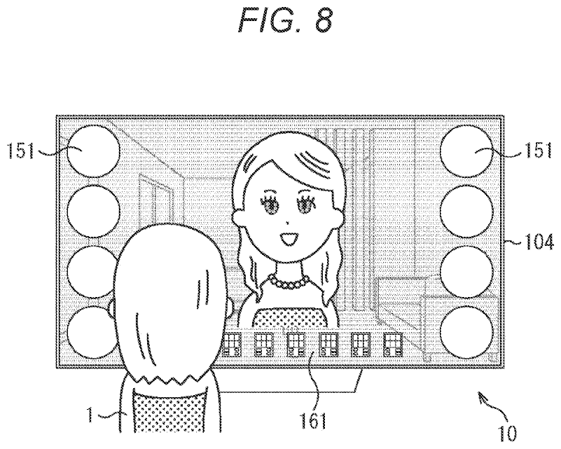

Thereafter, for example, the user 1 can purchase cosmetics for makeup as displayed by the AR technology and put on makeup, change into recommended costumes, and wear accessories to check the state after the makeup in the video displayed on the display device 10 (FIG. 8). Note that, in FIG. 8, the video displayed on the display device 10 is an actual video captured by the camera unit 107, and is not a video in which various information is superimposed and displayed by the AR technology. Furthermore, the costumes and accessories displayed by the AR technology may not be possessed by the user 1, and the user 1 may be encouraged to purchase those costumes and accessories.

By the way, in the display device 10, the background video of the user 1 is blurred, but by blurring the background, for example, the cluttered state in the room is not recognized.

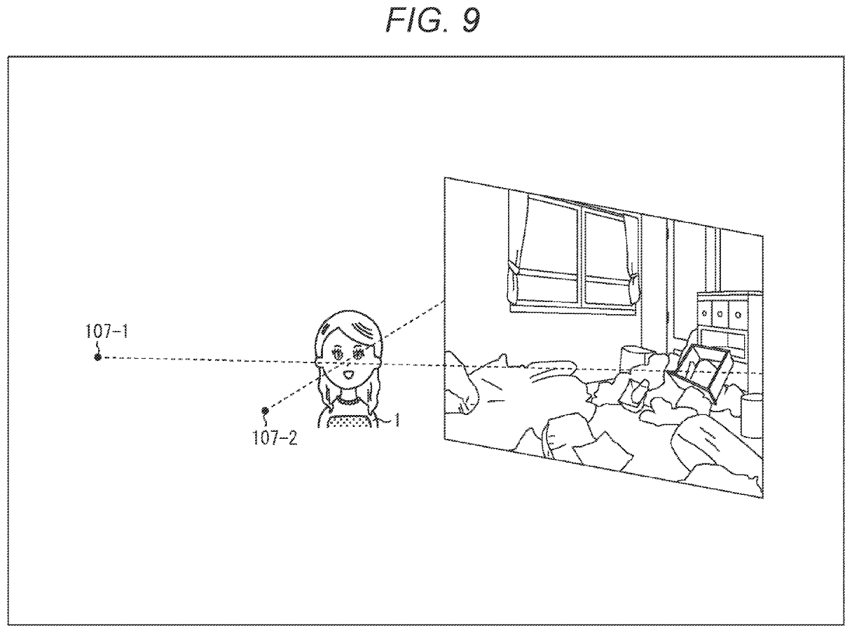

Here, as shown in FIG. 9, for example, one camera unit 107-1 and one camera unit 107-2 are attached to the frame of (the liquid crystal display unit 123 of) the display unit 104 of the display device 10 on the left and right sides, respectively, and the user 1 is captured by the two camera units 107-1 and 107-2. In this way, by using the two camera units 107-1 and 107-2 to capture the user 1 from two different directions simultaneously, information about the depth can be obtained, and the region of the face or (each part of) the body of the user 1 in close proximity can be extracted.

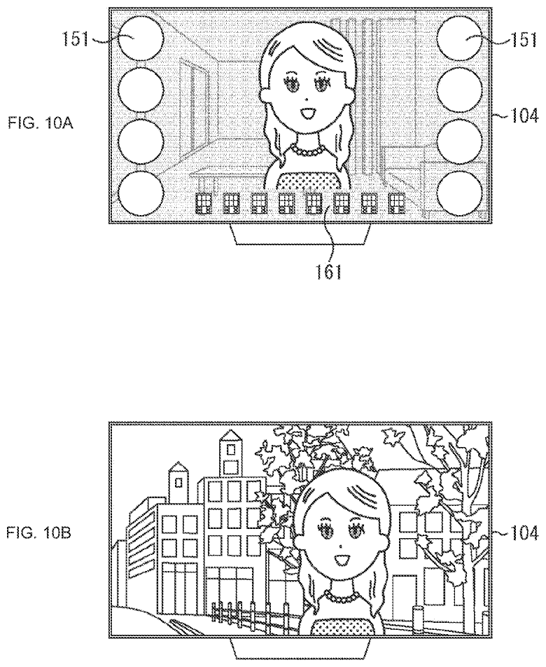

Then, in the display device 10, the control unit 100 can blur the region (background region) excluding the extracted region of the face or body of the user 1 to blur the cluttered state in the room (A of FIG. 10). Note that video processing for the background video (region) is not limited to the blurring processing, but other processing may be applied. For example, the control unit 100 may perform synthesis processing of masking the extracted region of the face or body of the user 1 to synthesize videos of different backgrounds (for example, an image of a building at a party venue) (B of FIG. 10).

### Third Example

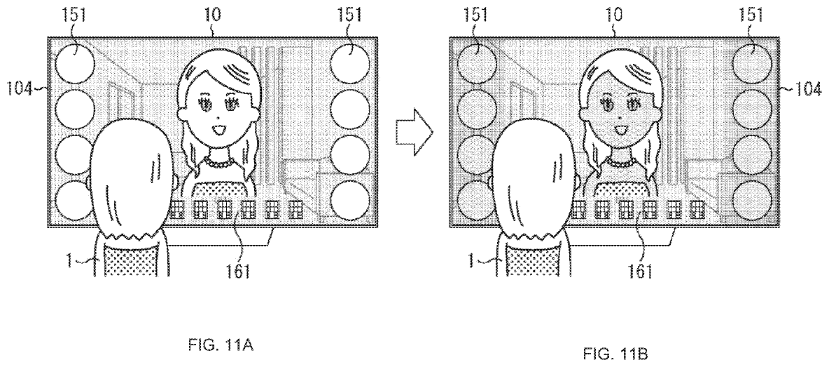

FIG. 11 shows a third example of a display screen displayed on the display device 10.

In FIG. 11, the display device 10 detects the color temperature in the room (periphery) with the sensor unit 108 such as a color sensor, and reproduces the color temperature of a destination (for example, a party venue at night) of the user 1 with respect to the detected color temperature by controlling the backlight 125 of (the lighting region corresponding to the plurality of lights 151 displayed on) the display unit 104 so as to emulate the ambient light according to the situation. By this ambient light emulation, the user 1 can check whether the makeup looks good when he/she actually goes out (B of FIG. 11).

Note that the information regarding the destination of the user 1 is registered in advance, but as this registration method, of course, the display device 10 is operated, and for example, a dedicated application is activated on a mobile terminal such as a smartphone to perform registration, or information regarding the destination may be acquired in cooperation with a schedule application used by user 1. Furthermore, instead of using the sensor unit 108 such as a color sensor, the color temperature in the room in which the display device 10 is installed may be detected by analyzing the image frame captured by the camera unit 107.

### Fourth Example

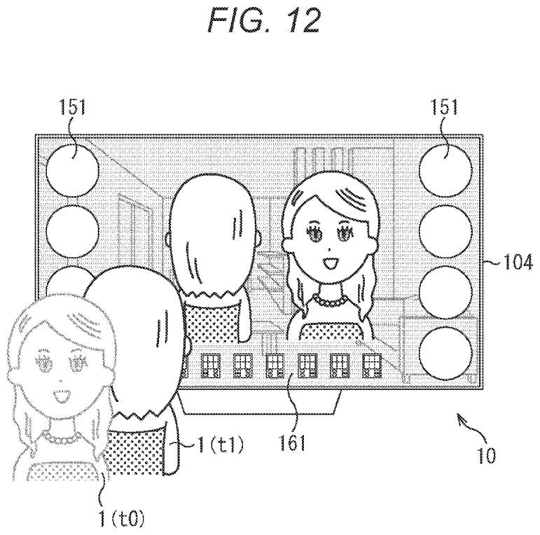

FIG. 12 shows a fourth example of a display screen displayed on the display device 10.

In FIG. 12, the display device 10 captures the user 1 located in front thereof with the camera unit 107, displays the video on the display unit 104, and records (or buffers) the data of the video on the recording unit 106. Therefore, the display device 10 can display the past video recorded (or buffered) in the recording unit 106 together with the real-time video.

For example, a case is assumed in which the user 1 facing the display screen side of the display device 10 at present (time t1) faced the opposite side, i.e., faced away from the display screen of the display device 10 X seconds before (time t0). In this case, since the video data of the user 1 facing backward is recorded in the recording unit 106, the display device 10 can display the videos of the user 1 at the present (time t1) and X seconds before (time t0) at the same time. Therefore, the user 1 can check not only the current front view of himself/herself but also the back view of himself/herself in the past (for example, a few seconds ago) displayed with a time difference (time shift).

Furthermore, in this example, the case where the user 1 faces away from the display screen of the display device 10 has been described, but the orientation of the user 1 is not limited to the backward, but, for example, when the video data of the user 1 in sideways orientation is recorded, the user 1 when checking the makeup or costumes can also check his/her front view and back view as well as his/her profile. Note that the video displayed on the display screen of the display device 10 can be switched not only to a mirror image but also to a normal image. For example, by switching the display from a mirror image to a normal image, the user 1 can check his/her view as seen by others.

### Fifth Example

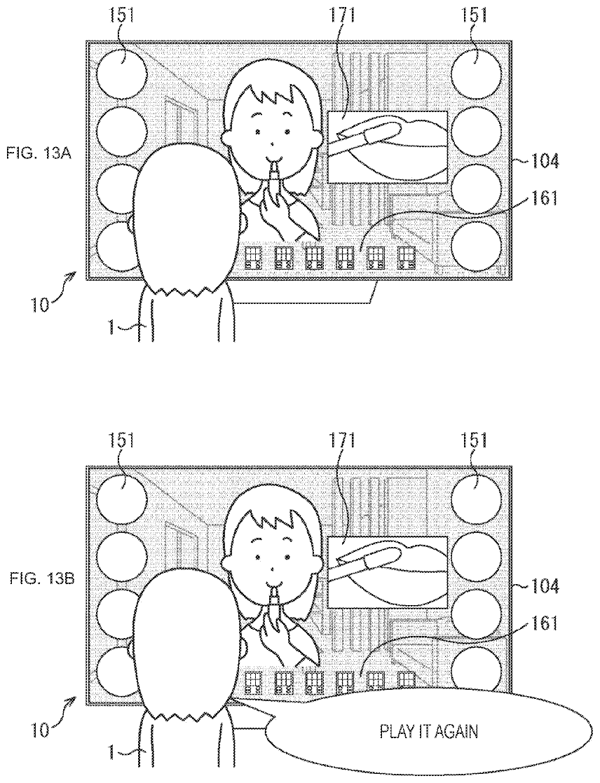

FIG. 13 shows a fifth example of a display screen displayed on the display device 10.

In FIG. 13, the display device 10 captures the user 1 located in front thereof with the camera unit 107, displays the video, and reproduces a tutorial moving image 171 for makeup (A of FIG. 13). Therefore, the user 1 can make up while checking the content of the tutorial moving image 171.

Here, a scene is assumed in which in a case where the user 1 wants to see a certain scene of the tutorial moving image 171 again and makes an utterance “play it again” (B of FIG. 13). At this time, in the display device 10, the utterance of the user 1 is collected by the microphone unit 109, and the sound recognition processing for the sound signal is performed. In this sound recognition processing, sound data is converted into text data by appropriately referring to a database or the like for sound text conversion.

Semantic analysis processing is performed on a sound recognition result obtained in this way. In this semantic analysis processing, the sound recognition result (text data), which is a natural language, is converted into an expression that can be understood by a machine (display device 10) by appropriately referring to a database for understanding a spoken language, for example. Here, for example, as a semantic analysis result, an intention (intent) that the user 1 wants to execute and an entity information (entity) that is a parameter thereof are obtained.

The display device 10 rewinds the tutorial moving image 171 on the basis of the semantic analysis result so that the target scene is reproduced again. Since the display device 10 supports such sound operation, the user 1 can operate the moving image reproduction by a sound even if both hands are full during makeup.

Note that in the example of FIG. 13, the case where the rewind is performed according to the sound operation as the reproduction control of the tutorial moving image 171 is illustrated. However, it is not limited to the rewind, but, for example, the reproduction control such as fast forward, pause, and slow reproduction may be performed according to the sound operation by the user 1. Furthermore, the tutorial moving image 171 is reproduced as communication content distributed from the server 30-3, for example. Moreover, a part of the processing such as the sound recognition processing and the semantic analysis processing performed by the display device 10 may be performed by a dedicated server 30 such as a recognition/analysis server that performs sound recognition and or semantic analysis via the network 40.

Furthermore, in the example of FIG. 13, the case where the reproduction of the tutorial moving image 171 is operated by a sound has been described, but the target of this sound operation is not limited to this, and for example, an instruction to change the pattern of the eye-catching lighting may be given, an instruction to change the background may be given, an instruction to emulate ambient light may be given, and an instruction to display an enlarged video may be given. Moreover, the display of a mirror image and the display of a normal image may be switched as the video displayed on the display device 10 by the sound operation by the user 1.

### Sixth Example

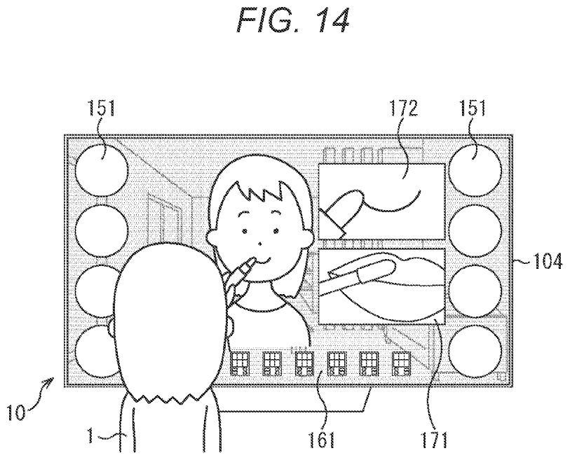

FIG. 14 shows a sixth example of a display screen displayed on the display device 10.

In FIG. 14, the display device 10 displays the video of the user 1, the tutorial moving image 171 for makeup, and an enlarged video 172 showing a part of the user 1 to be made up (for example, the mouth to which a lipstick is applied) in a partially enlarged scale. Therefore, the user 1 can make up while checking the enlarged video 172 displayed in real time of the mouth or the like on which the lipstick is applied by comparing it with the tutorial moving image 171 such as how to apply the lipstick.

(Example of Switching to the Smart Mirror Function)

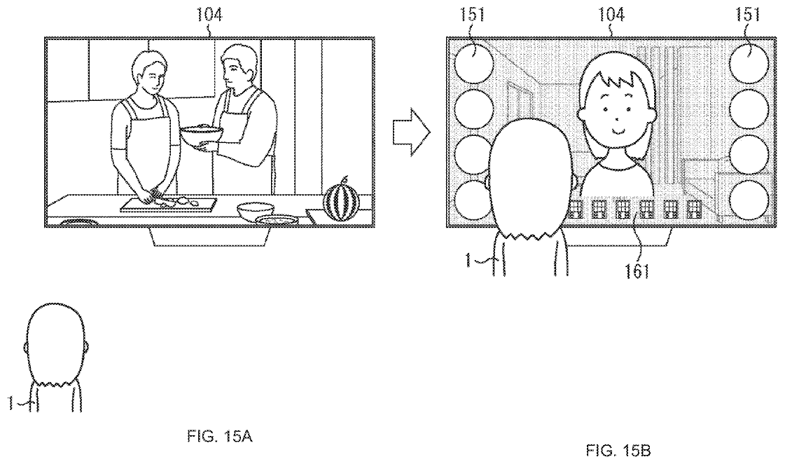

Note that the timing of switching between a normal television function and the smart mirror function in the display device 10 can be triggered by, for example, whether the position of the user 1 with respect to the display device 10 is within a predetermined range. That is, in the display device 10, for example, the position (current position) of the user 1 is detected by the sensor unit 108 such as a distance measuring sensor, and in a case where a value corresponding to the detected position is equal to or greater than a predetermined threshold value, the position of the user is outside of the predetermined range so that the normal television function is executed (A of FIG. 15).

On the other hand, in the display device 10, in a case where the value corresponding to the detected position is less than the predetermined threshold value, the position of the user is within the predetermined range so that the smart mirror function is executed (B of FIG. 15). That is, in a case where the user 1 makes up, it is assumed that the user 1 comes to a position close to the display device 10 to some extent, and therefore, this is used as a trigger here.

Furthermore, here, processing such as face recognition processing using the image frame captured by the camera unit 107 may be performed. For example, in the display device 10 as a television receiver, by registering the face information of the user who uses the smart mirror function in advance and executing the face recognition processing, for example, in a case where a family of four is assumed, when the father or the son approaches the display device 10, the normal television function is maintained, and when the mother or the daughter approaches the display device 10, the smart mirror function is executed.

(Flow of Processing)

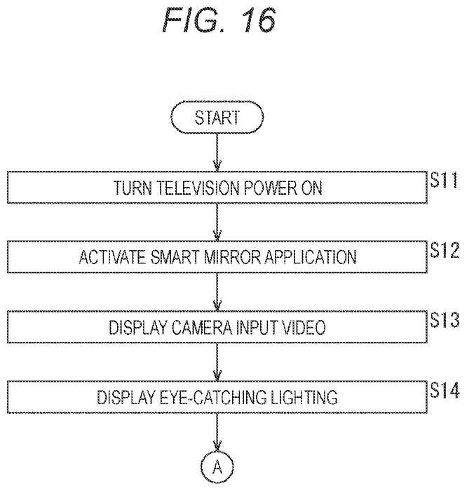

Next, the flow of processing executed by the display device 10 will be described with reference to the flowcharts of FIGS. 16 to 19.

The display device 10 turns on the power in a case where a predetermined operation is performed by the user 1 (S11). Therefore, in the display device 10, the power from the power supply unit 110 is supplied to each unit, and for example, the video of a selected television program is displayed on the display unit 104.

Then, the display device 10 activates the smart mirror application (S12). Here, for example, the control unit 100 activates the smart mirror application recorded in the recording unit 106 in a case where the position of the user 1 with respect to the display device 10 is within the predetermined range on the basis of the detection result from the sensor unit 108.

Then, in the display device 10, when the smart mirror application is activated, a camera input video and the eye-catching lighting are displayed (S13, S14). Here, the control unit 100 performs control so that the video of the image frame captured by the camera unit 107 and the plurality of lights 151 as the eye-catching lighting are displayed on the display unit 104. Note that, here, as described above, for example, by applying the technology “luminance enhancement” to increase the power of the backlight 125 in the white display portion (lighting region), the eye-catching lighting can be realized.

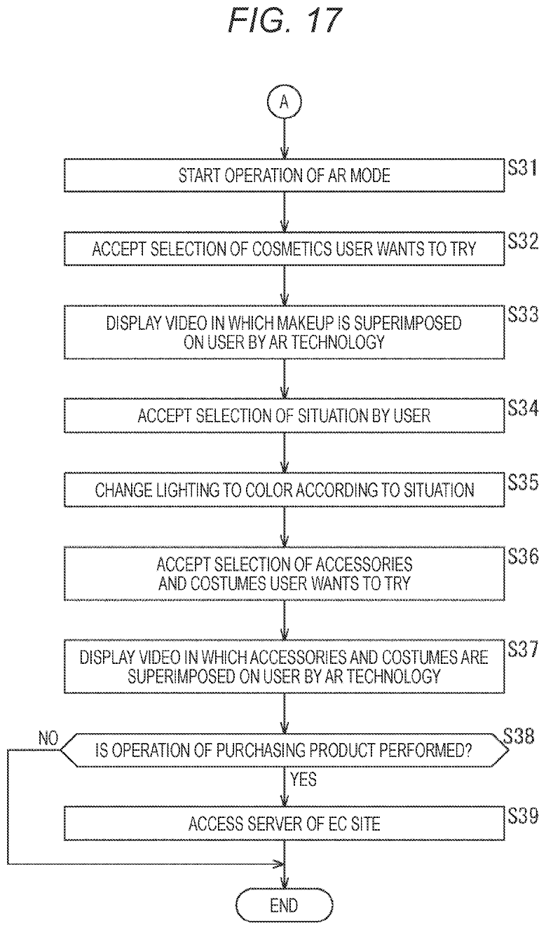

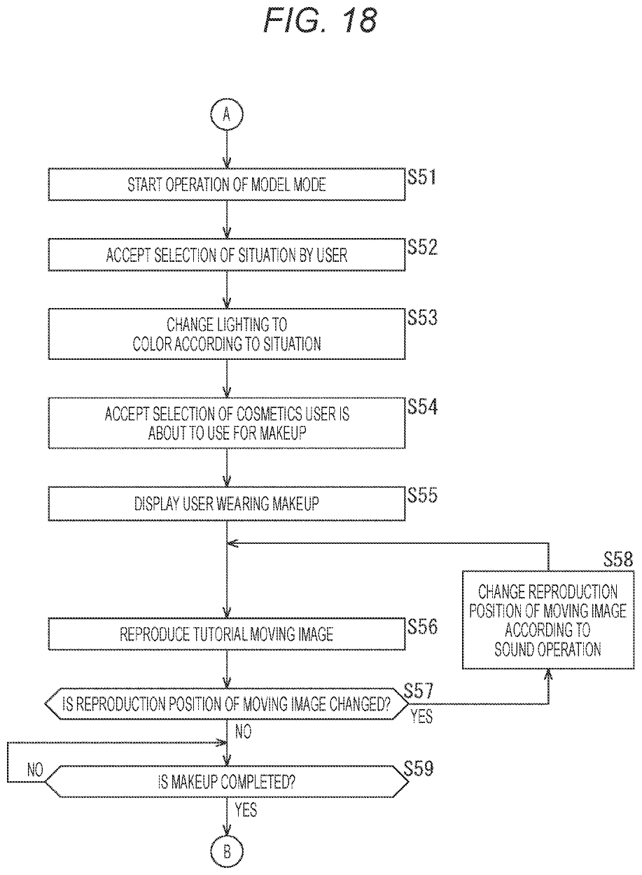

Therefore, in (the display unit 104 of) the display device 10, for example, the display screen shown in FIG. 4 is displayed, and the user can use the smart mirror function. Thereafter, various operations are assumed as the operation of the display device 10, and here, as an example, the operation of the AR mode shown in FIG. 17 and the operation of the model mode shown in FIG. 18 will be described.

First, the operation of the AR mode by the display device 10 will be described with reference to FIG. 17. The display device 10 starts the operation of the AR mode in a case where a predetermined operation is performed by the user 1 (S31).

The display device 10 accepts the selection of cosmetics that the user 1 wants to try (S32). Here, for example, on the display screen of the display unit 104, desired cosmetics according to the predetermined operation by the user 1 are selected from the product information 161 displayed in the lower region.

The display device 10 displays a video in which makeup is superimposed on the user 1 by the AR technology (S33). Here, the control unit 100 performs control such that, as the video of the user 1 included in the image frame captured by the camera unit 107, a video in which makeup according to the cosmetics selected by the user 1 in the processing of step S32 is displayed on the display unit 104. Therefore, (the display unit 104 of) the display device 10 displays, for example, the display screen shown in A of FIG. 7.

Next, the display device 10 accepts the selection of a situation by the user 1 (S34). Here, the control unit 100 selects a situation (for example, outdoors, a party, or the like) according to the destination of the user 1, which is input according to a predetermined operation by the user 1.

The display device 10 changes the illumination to a color that matches the situation (S35). Here, the control unit 100 causes the backlight 125 in the lighting region to reproduce the color temperature according to the situation (for example, outdoors or a party) selected in the processing of step S34 to change the color of the plurality of lights 151 displayed on the display unit 104 (for example, change from white to reddish color). Therefore, in (the display unit 104 of) the display device 10, for example, the display screen shown in B of FIG. 11 (costumes and accessories are not superimposed) is displayed, and the ambient light according to the situation is emulated.

Next, the display device 10 accepts the selection of accessories and costumes that the user 1 wants to try (S36). Here, for example, from the wardrobe registered in advance, desired accessories and costumes according to a predetermined operation by the user are selected.

The display device 10 displays a video in which accessories and costumes are superimposed on the user 1 by the AR technology (S37). Here, the control unit 100 performs control such that, as the video of the user 1 included in the image frame captured by the camera unit 107, a video in which makeup is performed and accessories and costumes selected in the processing of step S36 are superimposed is displayed on the display unit 104. Therefore, (the display unit 104 of) the display device 10 displays, for example, the display screen shown in B of FIG. 11.

Thereafter, it is determined whether the user 1 performs an operation of purchasing the product (selected cosmetics) (S38). In a case where it is determined that the user 1 performs an operation of purchasing the product (“YES” in S38), the display device 10 accesses the server 30-1 that provides an EC site of the desired cosmetics via the network 40 (S39). Therefore, the user 1 can purchase the desired cosmetics using the EC site. Note that, here, not only cosmetics, but, for example, accessories and costumes that the user 1 does not possess can be purchased by using the EC site in a case where the user 1 likes those accessories and costumes by displaying the accessories and the cosmetics in a superimposing manner.

By operating the display device 10 in the AR mode in this way, the user 1 can try makeup, accessories, and costumes.

Next, the operation of the model mode by the display device 10 will be described with reference to FIG. 18. The display device 10 starts the operation of the model mode in a case where a predetermined operation is performed by the user 1 (S51).

The display device 10 accepts the selection of a situation by the user 1 (S52). Here, the control unit 100 selects a situation (for example, outdoors, a party, or the like) according to the destination of the user 1.

The display device 10 changes the illumination to a color that matches the situation (S53). Here, the control unit 100 causes the backlight 125 in the lighting region to reproduce the color temperature according to the situation (for example, outdoors or a party) selected in the processing of step S52 to change the color of the plurality of lights 151 displayed on the display unit 104. Therefore, the display device 10 emulates the ambient light according to the situation.

The display device 10 accepts the selection of cosmetics that the user 1 is about to use for makeup (S54). Here, for example, on the display screen of the display unit 104, cosmetics (cosmetics used for makeup) according to the predetermined operation by the user 1 are selected from cosmetics displayed in predetermined region.

The display device 10 displays a video (video of the user 1 who wears makeup) according to the image frame captured by the camera unit 107, and reproduces a tutorial moving image for makeup (S55, S56). Here, the communication unit 105 accesses the server 30-3 via the network 40 according to the control from the control unit 100, and streaming data of the tutorial moving image corresponding to the cosmetics (for example, lipstick) selected in the processing of step S54 is received. Then, in the display device 10, a reproduction player is activated by the control unit 100, and the streaming data is processed to reproduce the tutorial moving image.

Therefore, (the display unit 104 of) the display device 10 displays, for example, the display screen shown in A of FIG. 13. The user 1 can make up according to the model while watching the tutorial moving image 171.

Thereafter, it is determined whether to change the reproduction position of the tutorial moving image (S57). In a case where it is determined that the reproduction position of the tutorial moving image is to be changed (“YES” in S57), the display device 10 changes the reproduction position of the tutorial moving image according to the sound operation by the user 1 (S58).

Here, for example, in a case where the user 1 makes an utterance “playing it again”, the sound is collected by the microphone unit 109. Therefore, the control unit 100 performs processing such as the sound recognition processing or the semantic analysis processing on the sound signal to control the reproduction position of the tutorial moving image 171 to be reproduced by the reproduction player (B of FIG. 13).

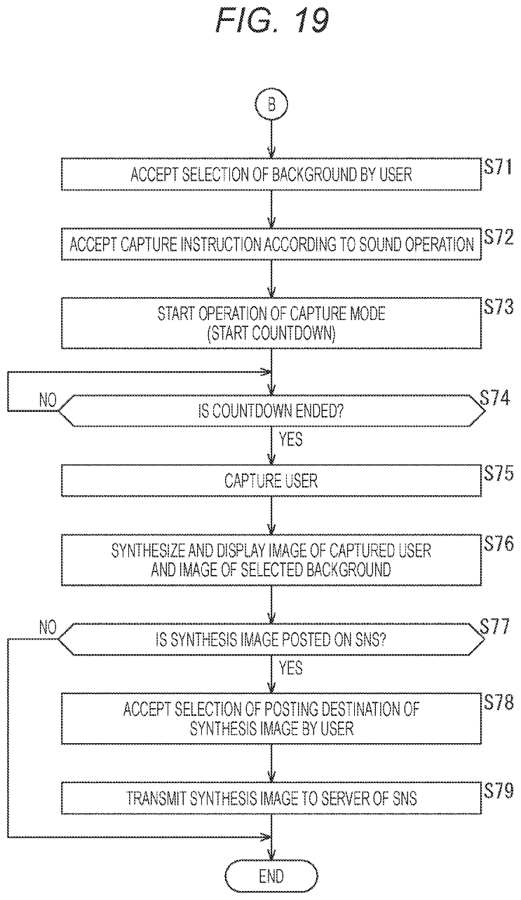

When the processing of step S58 ends, the processing returns to step S56, and the processing of step S56 and subsequent steps is repeated. Further, in a case where it is determined that the reproduction position of the tutorial moving image is not to be changed (“NO” in S57), the processing proceeds to step S59. In this determination processing, it is determined whether or not the makeup by the user 1 is completed (S59). Then, in a case where it is determined that the makeup by the user 1 is completed (“YES” in S59), the display device 10 ends the operation of the model mode, and for example, the operation of a capture mode shown in FIG. 19 is performed.

The display device 10 accepts the selection of a background by the user 1 (S71). Furthermore, the display device 10 accepts a capture instruction according to the sound operation by the user 1 (S72).

Then, in a case where the display device 10 accepts the capture instruction from the user 1 in the processing of step S72, the display device 10 starts the operation of the capture mode (S73). At this time, the display device 10 starts the countdown until the actual capture is performed, and when the countdown ends (“YES” in S74), the camera unit 107 captures the user 1 (S75).

Then, the display device 10 synthesizes and displays the captured image of the user 1 and the selected background image (S76). Here, for example, the control unit 100 performs mask processing on the region of the face or body of the user 1 extracted from the image frame obtained in the processing of step S75, and performs synthesis processing of synthesizing the background image selected in the processing of step S71 (e.g., an image of a building at a party venue), so that the resulting synthesis image is displayed.

At this time, it is determined whether or not the user 1 posts the synthesis image to an SNS (S77). In a case where it is determined that posting to the SNS is performed (“YES” in S77), the display device 10 accepts the selection of the posting destination of the synthesis image by the user 1 (S78). Here, for example, a list of SNSs in which the user 1 is registered as a member is displayed, and the SNS to which the synthesis image is posted can be selected from the list.

Then, the display device 10 transmits the synthesis image data to the server 30-2 of the selected SNS (S79). Here, by the communication unit 105, the synthesis image data obtained in the processing of step S76 is transmitted via the network 40 to the server 30-2 of the SNS selected in the processing of step S78. Therefore, the synthesis image is posted on the SNS, and the synthesis image can be viewed by, for example, a friend or family member of the user 1 using a mobile terminal or the like.

Note that in a case where it is determined not to post the synthesis image to SNS (“NO” in S77), the processing in steps S78 and S79 is skipped, and the processing of FIG. 19 ends. In this case, for example, the data of the synthesis image is recorded in the recording unit 106.

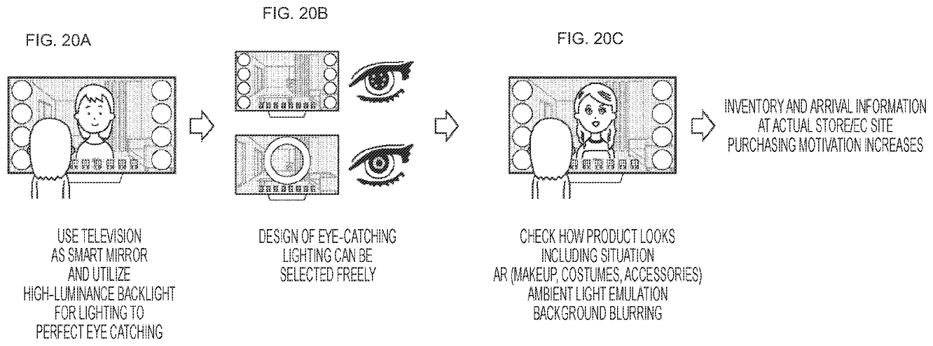

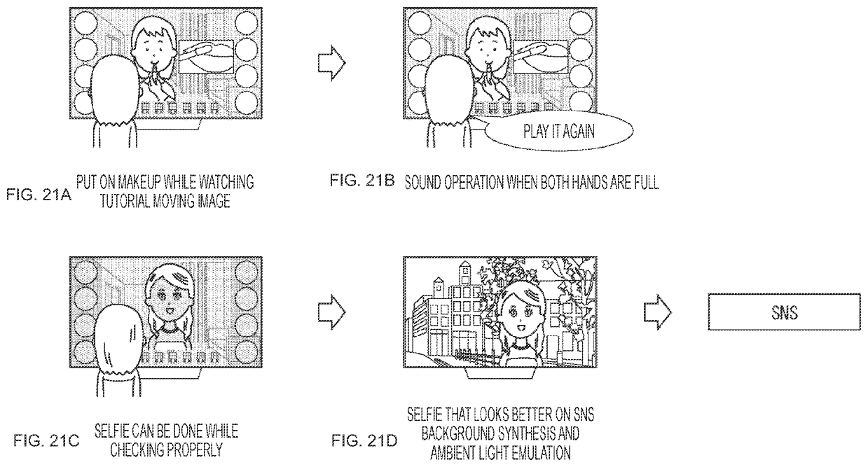

The flow of processing executed by the display device 10 has been described above. The summary of the above flow of processing can be as shown in FIGS. 20 and 21, for example.

That is, the display device 10 as a television receiver has a function as a smart mirror, and by using the high-luminance backlight 125 as the eye-catching lighting, the user 1 also can perfect the eye catching (A of FIG. 20). Furthermore, here, the design of the eye-catching lighting can be freely selected from a plurality of designs (B of FIG. 20).

Moreover, in the display device 10, when the AR technology is used to add information such as makeup, costumes, and accessories to the user 1 in the real space to expand the real world, the ambient light is emulated, or the background is blurred, it is possible to check how the product looks, including the situation (C of FIG. 20). Then, the display device 10 presents the inventory and arrival information of the product at an actual store or accesses the server 30-1 of the EC site and presents the product purchase page, enabling improvement of the motivation of purchasing the product by the user 1. In this way, the display device 10 as a television receiver can improve the user experience (UX).

Furthermore, since the display device 10 as a television receiver can reproduce the tutorial moving image as a model when the user 1 makes up, the user 1 can make up while watching the tutorial moving image (A of FIG. 21). At this time, since the user 1 can give an instruction by a sound operation in a case of performing an operation (for example, rewind) for the tutorial moving image, the user 1 can perform an operation even when both hands are full during the makeup work (B of FIG. 21).

Moreover, in the display device 10, in a case where an image (synthesis image) captured by the user 1 is posted to the SNS, for example, the self-portrait (selfie) image (video) can be checked in advance (C of FIG. 21) or the synthesis image in which the background is synthesized can be checked in advance (D of FIG. 21). Therefore, the user 1 can post an image that looks better on the SNSs. In this way, the display device 10 as a television receiver can improve the user experience (UX).

<2. Variation>

In the above description, the display device 10 has been described as being a television receiver, but is not limited to this, but may be electronic devices such as display devices, personal computers, tablet terminals, smartphones, mobile phones, head mounted displays, and game machines.

Furthermore, in the above description, the case where the display unit 104 of the display device 10 includes the liquid crystal display unit 123 and the backlight 125 has been described, but the configuration of the display unit 104 is not limited to this, and, for example, the display unit 104 may include a self-emitting display unit and its luminance may be controlled.

(Another Configuration of the Display Unit)

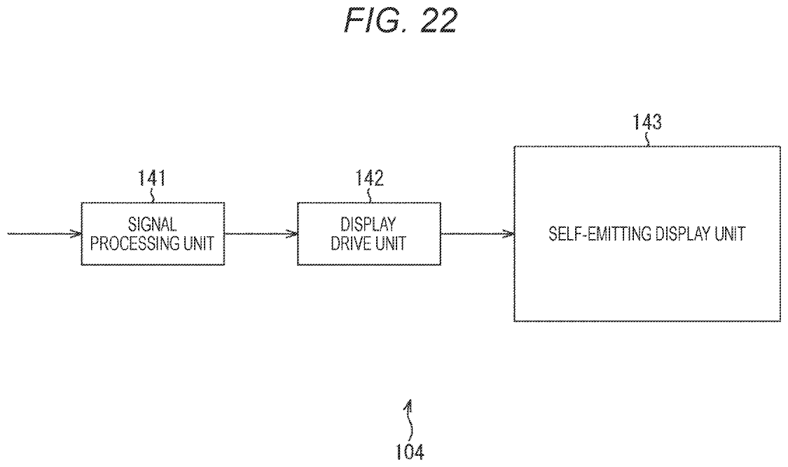

FIG. 22 is a block diagram showing another configuration example of the display unit 104 of FIG. 2.

In FIG. 22, the display unit 104 includes a signal processing unit 141, a display drive unit 142, and a self-emitting display unit 143.

The signal processing unit 141 performs predetermined video signal processing on the basis of a video signal input thereto. In this video signal processing, a video signal for controlling the drive of the self-emitting display unit 143 is generated and supplied to the display drive unit 142.

The display drive unit 142 drives the self-emitting display unit 143 on the basis of the video signal supplied from the signal processing unit 141. The self-emitting display unit 143 is a display panel in which pixels including self-emitting elements are arranged in a two-dimensional manner, and performs display according to the drive from the display drive unit 142.

Here, the self-emitting display unit 143 is, for example, a self-emitting display panel such as an organic EL display unit (OLED display unit) using organic electroluminescence (organic EL). That is, in a case where the organic EL display unit (OLED display unit) is adopted as the self-emitting display unit 143, the display device 10 is an organic EL display device (OLED display device).

An organic light emitting diode (OLED) is a light emitting element having a structure in which an organic light emitting material is sandwiched between a cathode and an anode, and constitutes a pixel arranged two-dimensionally on the organic EL display unit (OLED display unit). The OLED included in this pixel is driven according to a drive control signal (OLED drive control signal) generated by the video signal processing. Note that, in the self-emitting display unit 143, each pixel includes, for example, four sub-pixels, red (R), green (G), blue (B), and white (W).

### Combination of the Embodiments

Note that, in the above description, a plurality of display examples is shown as the display screen displayed on the display device 10, but the display examples of each display screen may of course be displayed independently, and a display screen including a combination of a plurality of display examples may be displayed. Furthermore, in the description above, the system means a cluster of a plurality of constituent elements (an apparatus, a module (component), or the like), and it does not matter whether or not all the constituent elements are present in the same enclosure.

<3. Configuration of Computer>

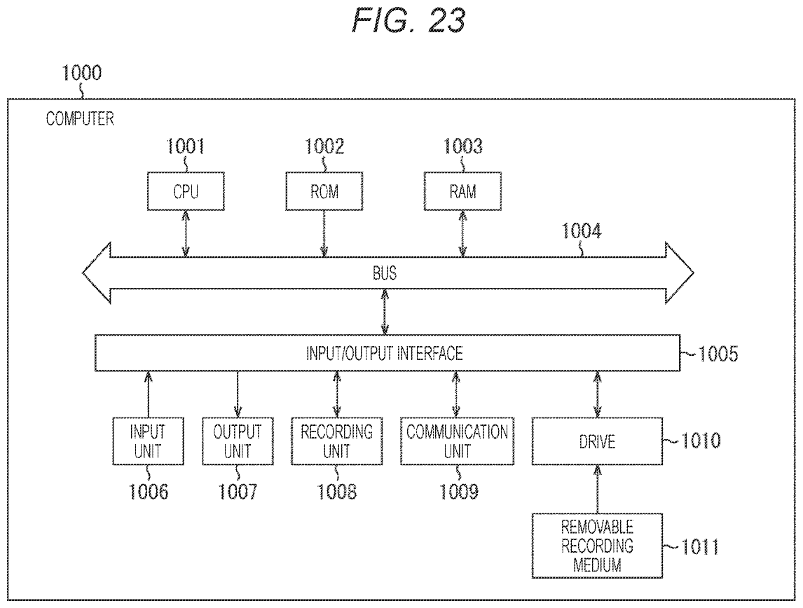

The series of processing described above (e.g., processing shown in the flowcharts of FIGS. 16 to 19) can be executed by hardware and can also be executed by software. In a case where the series of processing is executed by software, a program constituting the software is installed in a computer of each device. FIG. 23 is a block diagram showing a configuration example of hardware of a computer in which the series of processing described above is executed by a program.

In the computer 1000, a central processing unit (CPU) 1001, a read only memory (ROM) 1002, a random access memory (RAM) 1003, are interconnected by a bus 1004. An input/output interface 1005 is further connected to the bus 1004. An input unit 1006, an output unit 1007, a recording unit 1008, a communication unit 1009, and a drive 1010 are connected to the input/output interface 1005.

The input unit 1006 includes a microphone, a keyboard, a mouse, and the like. The output unit 1007 includes a speaker, a display, and the like. The recording unit 1008 includes a hard disk, a non-volatile memory, and the like. The communication unit 1009 includes a network interface and the like. The drive 1010 drives a removable recording medium 1011 such as a magnetic disk, an optical disk, a magneto-optical disk, or a semiconductor memory.

In the computer 1000 configured in the manner described above, the series of processing described above is performed, for example, such that the CPU 1001 loads a program recorded in the ROM 1002 or the recording unit 1008 into the RAM 1003 via the input/output interface 1005 and the bus 1004 and executes the program.

The program to be executed by the computer 1000 (CPU 1001) can be provided by being recorded on the removable recording medium 1011, for example, as a package medium or the like. Furthermore, the program can be provided via a wired or wireless transmission medium such as a local area network, the Internet, or digital satellite broadcasting.

In the computer 1000, the program can be installed on the recording unit 1008 via the input/output interface 1005 when the removable recording medium 1011 is mounted on the drive 1010. Furthermore, the program can be received by the communication unit 1009 via a wired or wireless transmission medium and installed on the recording unit 1008. In addition, the program can be pre-installed on the ROM 1002 or the recording unit 1008.

Here, in the present specification, the processing performed by the computer according to the program is not necessarily needed to be performed in chronological order along the procedure described as the flowchart. In other words, the processing performed by the computer according to the program also includes processing that is executed in parallel or individually (e.g., parallel processing or processing by an object). Furthermore, the program may be processed by a single computer (processor) or may be processed in a distributed manner by a plurality of computers.

Note that the embodiment of the present technology is not limited to the aforementioned embodiments, but various changes may be made within the scope not departing from the gist of the present technology.

For example, each step of the processing shown in the flowcharts of FIGS. 16 to 19 can be executed by a single device or shared and executed by a plurality of devices. Moreover, in a case where a single step includes a plurality of pieces of processing, the plurality of pieces of processing included in the single step can be executed by a single device or can be shared and executed by a plurality of devices.

Note that, the present technology may adopt the configuration described below.

(1)

A display device including:

a control unit that, when displaying a video corresponding to an image frame obtained by capturing a user on a display unit, controls luminance of a lighting region including a first region including the user in the image frame and at least a part of a second region of the second region excluding the first region to cause the lighting region to function as a light that emits light to the user.

(2)

The display device according to (1), in which

the display unit functions as a mirror reflecting the user by displaying a video of a mirror image or normal image of the user, and

the light functions as a light used when the user puts on makeup.

(3)

The display device according to (2), in which

the control unit superimposes various information on the video of the user included in the first region by AR technology.

(4)

The display device according to (3), in which

the control unit displays a video in which makeup is applied to a video of a face of the user.

(5)

The display device according to (4), in which

the control unit displays information regarding cosmetics and applies makeup according to the cosmetics selected by the user.

(6)

The display device according to any of (3) to (5), in which

the control unit displays a video in which a video of at least one of an accessory or a costume is superimposed on the video of the user.

(7)

The display device according to any of (2) to (6), in which

the control unit displays a video in which predetermined video processing is performed on a background video included in the second region.

(8)

The display device according to (7), in which

the control unit performs blurring processing on the background video or synthesis processing for synthesizing the video of the user and another background video.

(9)

The display device according to any of (2) to (8), in which

the control unit controls a color temperature of the lighting region and emulates ambient light according to a situation.

(10)

The display device according to any of (2) to (9), in which

the control unit displays a video of a tutorial moving image according to makeup of the user.

(11)

The display device according to (10), in which

the control unit controls reproduction of the tutorial moving image according to a sound operation of the user.

(12)

The display device according to (10) or (11), in which

the control unit displays a video of a site of the user to be a target of makeup in a partially enlarged manner, which is a part of a video of a face of the user included in the first region.

(13)

The display device according to (5), further including: a communication unit that communicates with a server via a network,

in which

the communication unit accesses a server that provides a site for selling a product including the cosmetics and exchanges information regarding the product according to an operation of the user.

(14)

The display device according to any of (2) to (12), further including:

a communication unit that communicates with a server via a network,

in which

the communication unit accesses a server that provides an SNS and transmits an image after completion of makeup of the user according to an operation of the user.

(15)

The display device according to any of (2) to (12), further including:

a recording unit that records data of a video of the user included in the first region,

in which

the control unit displays the video of the user in a time-shifted manner on the basis of the data recorded in the recording unit.

(16)

The display device according to any of (2) to (12), in which

the lighting region includes a region including a region of at least a part of upper, lower, left, and right regions of a display screen in the display unit, or includes a donut-shaped region, and

the control unit controls luminance of the lighting region according to brightness of the lighting region.

(17)

The display device according to any of (2) to (12), in which

the display unit displays a video of content in a case where a position of the user is out of a predetermined range and functions as a mirror reflecting the user in a case where the position of the user is within the predetermined range.

(18)

The display device according to any of (1) to (17), in which

the display unit includes a liquid crystal display unit, and

the control unit controls luminance of a backlight provided with respect to the liquid crystal display unit.

(19)

The display device according to any of (1) to (18) being configured as a television receiver.

(20)

A display control method in which

a display device, when displaying a video corresponding to an image frame obtained by capturing a user on a display unit, controls luminance of a lighting region including a first region including the user in the image frame and at least a part of a second region of the second region excluding the first region to cause the lighting region to function as a light that emits light to the user.

### REFERENCE SIGNS LIST

10 Display device
20 Router
30-1 to 30-N Server
40 Network
100 Control unit
101 Tuner unit
102 Decoder unit
103 Speaker unit
104 Display unit
105 Communication unit
106 Recording unit
107 Camera unit
108 Sensor unit
109 Microphone unit
110 Power supply unit
121 Signal processing unit
122 Display drive unit
123 Liquid crystal display unit
124 Backlight drive unit
125 Backlight
141 Signal processing unit
142 Display drive unit
143 Self-emitting display unit
1000 Computer
1001 CPU

1. A display device comprising:
a control unit that, when displaying a video corresponding to an image frame obtained by capturing a user on a display unit, controls luminance of a lighting region including a first region including the user in the image frame and at least a part of a second region of the second region excluding the first region to cause the lighting region to function as a light that emits light to the user.

2. The display device according to claim 1, wherein
the display unit functions as a mirror reflecting the user by displaying a video of a mirror image or normal image of the user, and
the light functions as a light used when the user puts on makeup.

3. The display device according to claim 2, wherein
the control unit superimposes various information on the video of the user included in the first region by AR technology.

4. The display device according to claim 3, wherein
the control unit displays a video in which makeup is applied to a video of a face of the user.

5. The display device according to claim 4, wherein
the control unit displays information regarding cosmetics and applies makeup according to the cosmetics selected by the user.

6. The display device according to claim 3, wherein
the control unit displays a video in which a video of at least one of an accessory or a costume is superimposed on the video of the user.

7. The display device according to claim 2, wherein
the control unit displays a video in which predetermined video processing is performed on a background video included in the second region.

8. The display device according to claim 7, wherein
the control unit performs blurring processing on the background video or synthesis processing for synthesizing the video of the user and another background video.

9. The display device according to claim 2, wherein
the control unit controls a color temperature of the lighting region and emulates ambient light according to a situation.

10. The display device according to claim 2, wherein
the control unit displays a video of a tutorial moving image according to makeup of the user.

11. The display device according to claim 10, wherein
the control unit controls reproduction of the tutorial moving image according to a sound operation of the user.

12. The display device according to claim 10, wherein
the control unit displays a video of a site of the user to be a target of makeup in a partially enlarged manner, which is a part of a video of a face of the user included in the first region.

13. The display device according to claim 5, further comprising:
a communication unit that communicates with a server via a network,
wherein
the communication unit accesses a server that provides a site for selling a product including the cosmetics and exchanges information regarding the product according to an operation of the user.

14. The display device according to claim 2, further comprising:
a communication unit that communicates with a server via a network,
wherein
the communication unit accesses a server that provides an SNS and transmits an image after completion of makeup of the user according to an operation of the user.

15. The display device according to claim 2, further comprising:
a recording unit that records data of a video of the user included in the first region,
wherein
the control unit displays the video of the user in a time-shifted manner on a basis of the data recorded in the recording unit.

16. The display device according to claim 2, wherein
the lighting region includes a region including a region of at least a part of upper, lower, left, and right regions of a display screen in the display unit, or includes a donut-shaped region, and
the control unit controls luminance of the lighting region according to brightness of the lighting region.

17. The display device according to claim 2, wherein
the display unit displays a video of content in a case where a position of the user is out of a predetermined range and functions as a mirror reflecting the user in a case where the position of the user is within the predetermined range.

18. The display device according to claim 1, wherein
the display unit includes a liquid crystal display unit, and
the control unit controls luminance of a backlight provided with respect to the liquid crystal display unit.

19. The display device according to claim 1 being configured as a television receiver.

20. A display control method wherein
a display device, when displaying a video corresponding to an image frame obtained by capturing a user on a display unit, controls luminance of a lighting region including a first region including the user in the image frame and at least a part of a second region of the second region excluding the first region to cause the lighting region to function as a light that emits light to the user.
